(19) United States
(12) Patent Application Publication
(10) Pub. No.: US 2016/0174591 A1
(43) Pub. Date: Jun. 23, 2016

(54) PROCESS FOR COLD BREWING CACAO IN WATER BASED SOLUTION

(71) Applicant: Patricia Lampron, Champaign, IL (US)

(72) Inventor: Patricia Lampron, Champaign, IL (US)

(21) Appl. No.: 14/578,409

(22) Filed: Dec. 20, 2014

(51) Int. Cl. A23G 1/00; B65D 85/72; A23L 2/44; A23L 2/72; A23L 2/56; A23L 2/385; A23L 2/39; A23L 2/60; A23L 2/38

(52) U.S. Cl. CPC A23G 1/002; A23L 2/60; B65D 85/72; A23L 2/44; A23L 2/38; A23L 2/56; A23L 2/385; A23L 2/39; A23L 2/72; A23V 2002/00

(57) ABSTRACT

A method for preparing a cocoa beverage through a low temperature process is described. The process promotes the incorporation of desirable flavorings and biologically beneficial flavanols and methylxanthines. The low temperature brewing process prevents the beverage from entering the water-lipid chemical spinodal during low temperature storage and consumption, which would result in an unappealing phase separated liquid. Implementations of the invention are described based on raw unfermented cacao beans, fermented cacao beans, and roasted cacao beans steeped in water or flavored water.

### TECHNICAL FIELD

The present disclosure is related generally to a beverage product processed by cold brewing or steeping cacao in water or water-based solutions and more specifically to low fat water based cacao drinks processed at or below ambient temperature (25° C.). These beverages can be produced as ready-to-drink products or concentrates. Desirable embodiments maximize the concentrations of antioxidants and water-soluble flavorful components, while minimizing the incorporation of cacao fat.

### BACKGROUND

Raw cacao, roasted cacao, and associated components and constituents such as cocoa nibs, cocoa solids, cocoa powder or cocoa bean extract, contain large amounts of water soluble flavanols and methylxanthines that have been reported to act as antioxidants, promote cardiovascular health, nervous function, and insulin resistance, amongst other benefits; in addition to a variety of water soluble vitamins and minerals.¹⁻⁵¹ Cacao is rich in theobromine, which is a stimulant that may have beneficial effects relative to caffeine, which is commonly found in related steeped beverages such as tea and coffee.⁵²⁻⁵⁷ Theobromine is believed to have a longer lasting stimulant effect, with less associated addiction or sleep disturbance.⁵⁸ These chemicals and compounds are desirable to consumers and can be delivered conveniently as a consumable beverage. In addition to these health benefits, such a product can provide an appealing taste, with or without flavoring additives such as sugar or complementary nuts, fruits, or vegetables. One challenge associated with brewing cacao by traditional hot brewing methods, defined here as nominally above room temperature, is its inherently high fat or lipid content, which tends to either melt at high temperature and have higher solubility in water at high temperature. When cool, for consumption as a cold drink, nominally room temperature or below, the cacao lipids phase separate due to their lower solubility at low temperatures and produce an unappealing texture and an unappealing visible lipid layer or lipid ring.⁴⁶ For this reason, cacao based beverages are typically consumed hot or are brewed in milk, whose inherent fat content and ability to form liposomes favors incorporation of cacao.⁵⁹⁻⁶⁵

A cold brewing, or steeping, process allows water soluble flavanols and methylxanthines to enter solution with limited incorporation of cacao fat, lipids, or cocoa butter, and circumvents the need for an acid treatment of the water that might alternatively be utilized to prevent cacao fat incorporation during hot brewing or steeping.⁴⁶

### RELEVANCE OF THE INVENTION AND DESCRIPTION OF RELATED ART

Finely ground cacao based beverages have been steeped in hot water since prior to cacao's introduction to western society. The hot beverage allows cacao fat, or cocoa butter, to best incorporate. Water soluble components have also been extracted from heated liquid cacao components and subsequent phase separation processes used to isolate the solids, fat, and water soluble components.⁶⁶ Steam-based extraction processes have also been developed.⁶⁷ Cold cacao beverages most frequently use milk or alcohol as the solvent.⁵⁹⁻⁶⁵ These solutions allow the cacao fat to best incorporate in the solution. Acid treatments may also be utilized to prevent fat incorporation into solution during hot brewing, or steeping.⁴⁶ This invention describes a low temperature process that dissolves the beneficial and desirable antioxidants, flavanols, methylxanthines, and stimlants theobromine and caffeine, from the cacao into water without significant incorporation of cacao fat, or cocoa butter. Since the product is processed and consumed at nominally the same temperature, the concentrations of dissolved species are always in equilibrium under conditions of consumptions and no phase separation occurs. The method avoids the need for chemical treatments, such as acid treatments, that may be considered undesirable by health conscious consumers.

### BRIEF SUMMARY

Described herein is the process for manufacturing an aqueous cacao based beverage via cold brewing, or cold steeping, cacao beans, or their processed components such as roasted cacao beans, cocoa powder, cocoa nibs, or any cocoa component, in water.

A process for producing a potable cacao based beverage by steeping potable water in cacao bean constituents in temperatures above the freezing point of the solution but below about 45 degrees F. In this regime limited cacao fat is incorporated into a solution, which prevents unappealing and visually observable cacao fat from forming in the beverage, while still producing a desirable roasted cacao flavor and incorporating beneficial antioxidants and stimulants.

### BRIEF DESCRIPTION OF THE DRAWINGS

FIG. 1. Schematic line drawings of the general process utilized for cold brewing cacao beans, showing the processing steps of roasting, winnowing, grinding, brewing, filtering, and packaging.

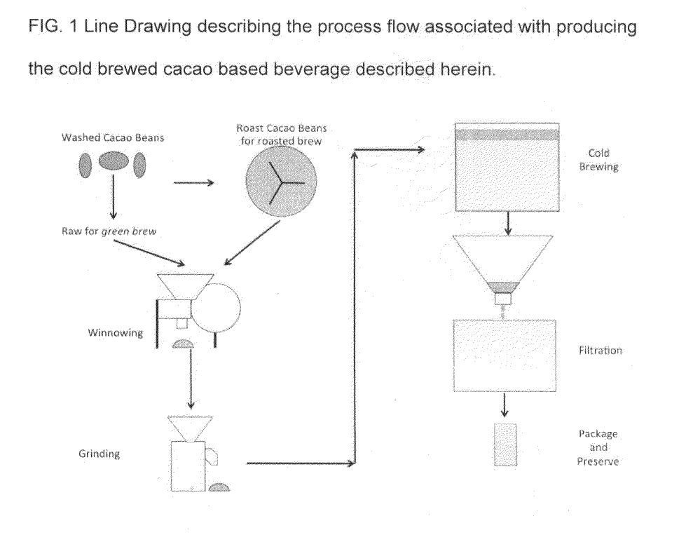

### DETAILED DESCRIPTION

The citation of published documents relevant to the current invention should not be misconstrued as an acknowledgement or endorsement of these documents being part of the state of the art or are general knowledge in the field. Portions of this source material may be incorporated into this document as allowed, however all terminology and/or phrases defined in the current patent documentation should not be modified through interpretation of the herein referenced source material. The present invention relates to a process for creating a beverage based on water steeped, or brewed, in cacao bean components at low temperatures. In the context of the current invention, the terms steep and brew are used interchangeably as they are nominally defined equivalently. Cacao-based or cocoa-based beverages traditionally utilize dairy or are brewed and consumed hot. This stems in part from the inherently high fat content of cacao, which incorporates best into alcohol, dairy, and high temperature solutions. Cold brewing suppresses incorporation of fat into the liquid, resulting in a healthy low calorie drink that remains nominally homogenous when cold. This beverage delivers beneficial antioxidants and stimulants. It is noted that cacao and cocoa may be used interchangeably in the many instances as cacao refers specifically to the bean, Theobroma Cacao, but many of its extracts are commonly referred to as cocoa, such as cocoa solids rather than cacao solids, which are functionally equivalent terms.

Dried cacao beans, also referred to as cocoa beans, contain approximately 30-35% lipids, 25-30% carbohydrates, 15% fiber, 10% protein, 4-6% polyphenols, 5% moisture, 3% ash, 1.5% xanthines, with the remainder comprising microconstituent minerals and compounds, some of which are water soluble and nutritionally valuable including Ca, Mg, K, Fe, Mn, Cu, Zn, and Se.⁶⁸ Extracting the polyphenols, xanthines, vitamins, and minerals in a delicious, healthy, and appealing beverage is a goal of the present invention. Cacao bean composition varies with tree genetics, growth conditions, and growth location. Appropriate beans can be selected to optimize flavor and nutrition. Similarly, processing steps familiar to those skilled in the art of cocoa processing, such as fermentation, roasting, mechanical attrition, conching, or Dutching, can affect the chemical composition of the product and can be optimized to balance nutrition and flavor.⁶⁹⁻⁷¹ Additionally, the ratio of cacao bean husk or skin, to cacao bean will affect the relative amounts of polyphenols, xanthines, and associated flavor profile.

This invention utilizes potable water as the base for steeping cacao or its by-products. This water base includes natural unprocessed water, or pre-processed water; sterilized water, purified water, flavored water, or alkaline water. The pre-processing steps are familiar to those skilled in the art and primarily intended to eliminate illness and disease causing agents, remove undesirable flavors, and remove insoluble impurities. Such processes include but are not limited to, carbon filtration, reverse osmosis filtration, heating, photon irradiation, or chemical treatment.

The potable water is steeped in cacao beans, roasted or unroasted, or its components at low temperatures, above the freezing point of the solution, but at or below temperatures typical of refrigerated cold beverages, approximately 45 degrees F. or 50 degrees F. maximum. The cold brewing step is critical to the process as it prevents the formation of a fat film at the surface of the liquid or a fat ring at the triple line bounding the surface, liquid, and container. During steeping below the melting temperature of the component fats, the fat can only enter solution up to its equilibrium solubility. However, when beverage is cooled, the solubility decreases exponentially with temperature and can phase separate. If the beverage is processed by steeping at temperatures sufficiently above the consumption temperature, then it will phase separate during storage at consumption temperature. The resultant phase separated beverages are visually undesirable and texturally undesirable during consumption. Steeping at or below the consumption temperature prevents super-saturation of the cacao fat in water at consumption and storage conditions, typically below 50 degrees F. Alternative chemical treatments to stabilize the fat in solution or as an emulsion such as surfactants, acid treatments, or other chemical additives that for example effectively reduce the heat of mixing between water and the cocoa fats are undesirable to many health conscious consumers.

A great variety of processes have been applied to extract flavorful or nutritious components from cacao. Notable amongst them are roasted cacao beans, cocoa nibs, cocoa butter, cocoa solids, defatted cocoa solids, chocolate, cocoa liquor. Any of these extracts could be utilized for cold brewing or cold steeping.

The flavor and health benefits of the cold brewed cacao beverage that is the subject of this patent may be enhanced through additives. For the purpose of producing a nominally natural product, one containing no artificial ingredients, it is particularly desirable to steep the cacao with water that has previously been steeped in another ingredient, co-steep the cacao with another ingredient, or steep an additional ingredient in the prepared cacao water. Example additional ingredients include but are not limited to edible grains, cereals, legumes, nuts, seeds, roots, tubers, fruits, spices, drupe seeds, gymnosperm seeds, or vegetables. Ideal examples of complementary ingredients include, rice, oats, hazelnuts, tea, vanilla, coffee, peanuts, almonds, soy, wheat, rye, aloe vera, citrus fruit, citrus fruit zest, cinnamon, anise, cardamom, cloves, mace, allspice, ginger, nutmeg, poppyseed, strawberry, blueberry, blackberry, raspberry, cherry, cranberry, stevia leaves, monk fruit, apple, plum, peach, pear, mangosteen, rambutan, dragon fruit, lychee, goji berry, apricot, currant, date, kola nut, or pistachio.

The flavor of the beverage can also be enhanced through the addition of common sweeteners including but not limited to sugars such as, monosaccharides, disaccharides, or polyhydric alcohols, or natural low-calorie sweeteners, such as stevia, thaumatin, monellin, pentadin, miraculin, monatin, mannitol, inulin, brassein, or curculin, or artificial sweeteners such as aspartame, cyclamate, or sucralose. Natural sweeteners are desirable to many health conscious consumers and are preferable additives in exemplary versions of the process.

In another form of the invention, the cold brewed cacao extract and any associated additives described here could also be concentrated into a water soluble product for producing flavorful and healthy beverages via reconstitution in water.

### DETAILED DESCRIPTION OF EXEMPLARY EMBODIMENTS

### Background

The flavor profile of the final product depends heavily on the time-temperature schedule utilized to roast the cacao. The effects of different treatments on the flavor of the cacao bean are well known to those experienced in the art. The effect of roasting also impacts the flavor profile of the cold brewed cacao water. Shorter roasting times and lower roasting temperatures result in more pungent and bitter brews while longer roasting times and higher roasting temperatures tend to favor less bitter brews with a roasted aroma. However, treatment for too long or at too high of a temperature produces cold brewed cacao waters with a burnt flavor. For embodiments of the cold brewed cacao water utilizing roasted cacao beans, the ideal roasting conditions fall in the time-temperature range on 60 minutes to 180 minutes between 250 degrees F. and 375 degrees F., but other implementations may utilize temperatures above 375 degrees F. for less than 60 minutes or temperatures below 250 degrees F. for more than 180 minutes. Often a short high temperature treatment, for example, but not limited to 450 degrees F. for 5 minutes, are imposed prior to longer heat treatment at lower temperature in order to aid the removal of the cacao bean shell during subsequent processing. Such techniques can be applied in the context of the current invention.

In one example, defined here as a green cold brew, the beverage is produced by steeping ground raw fermented, or unfermented, but unroasted, cacao beans in water. The cacao beans are prepared by grinding them using one or more of a variety of techniques well known to those versed in the art, including by use of a blade grinder, crushing, ball milling, or attrition milling. Reduction in particle size via these milling processes is useful in promoting the steeping process, since the characteristic time associated with the solution equilibrating will scale with the surface area of the particulate material. Prolonged milling can lead to chemical changes in the material, which are often promoted during the production of chocolate in the conching process. To limit associated chemical decomposition, in an ideal embodiment, milling should produce a final average particle size greater than approximately 50 microns. Fine milling also tends to heat the material, which could be undesirable for producing a green cold brew beverage, which could be particularly important to raw food consumers, who avoid foods processed at high temperatures typically about 100 degrees F., or 110 degrees F, or 120 degrees F. Similar results may be achieved with more coarse average particle sizes closer to 500 microns or 5 millimeters, but with prolonged steeping time. For production of green cold brew the cacao skin or shell may be left on or removed. This cacao bean product is then added to water that is untreated, pre-purified, or pre-flavored. The ratio of cacao to cold water can vary between 1 and 50% by volume. This mixture is then steeped cold between 32 degrees F. and 45 degrees F. for times varying between 30 mins and 3 days. The cacao solids are then filtered from the beverage utilizing one of several filtering techniques well known to those skilled in the art, such as gravitational filtration, drip filtration, press filtration, or centrifugation filtration performed continuously or in batches. The particle size, composition, and temperature all impact the ideal steeping time. We define three classes of beverage here, a light brew, which has subtle flavoring similar to other ‘flavored water’, a medium brew which has a flavor profile comparable to a moderate strength coffee, and a strong brew that has a flavor profile comparable to strong coffee. An exemplary light brew utilizes a 16 to 1 ratio by volume of water to ground cacao and is brewed for 6 to 24 hours. However, longer or shorter brewing times may be utilized to affect how much cocoa flavor the beverage has and how bitter it is. Longer times tend to make the brew more bitter while providing additional cacao flavor. An exemplary implementation uses a concentration close to 0.05% by volume. An exemplary medium brew utilizes a water to ground cacao ratio of 8 to 1 by volume and is brewed for 12 to 36 hours. Again longer or shorter times may be utilized to produce a quality beverage. An exemplary strong brew utilizes a water to ground cacao ratio of 4 to 1 by volume and brewing times between 12 and 48 hours. Quality beverages may also be produced utilizing shorter or longer brewing times. Other ratios of water to ground cacao are suitable for producing a beverage, with stronger flavor resulting from larger amounts of cacao. These beverages may be sweetened with natural or artificial sweeteners to make them more palatable to consumers. The beverages can be sweetened with sugars, sugar alcohols, or calorie-free sweeteners, using compositions and water to sweetener ratios that are well known to those familiar with related arts such as coffee and tea manufacturing. Creamers, dairy and non-dairy, can be utilized to suppress bitter flavors in the drink and could be a desirable additive. Appropriate selection of creamer chemistry and composition would be elementary for those skilled in the art of related product production such as cold coffee. Salts based on Na⁺, K⁺, or mixtures of Na⁺ and K⁺ may be added to suppress the bitter flavor and enhance the overall flavor, which is also common in other cacao based edible products. In each drink the salt concentration, by volume, should be in the range of 0.001 to 0.5%. To conclude the process, the beverage is preserved and packaged. A variety of techniques for bottling and preserving bottled beverages are known to those skilled in the art. The packaged product should have a shelf-life of at least 3 months, or 6 months, or 12 months.

In another example, a roasted cold brew is produced by steeping ground roasted cacao beans in water. The cacao beans are prepared by grinding them using one or more of a variety of techniques well known to those versed in the art, including by use of a blade grinder, crushing, ball milling, and/or attrition milling. Reduction in particle size via these milling processes is useful in promoting the steeping process, since the characteristic time associated with the solution equilibrating will scale with the surface area of the particulate material. An ideal embodiment utilizes an average particle size greater than approximately 50 microns. Similar results may be achieved with more coarse average particle sizes closer to 500 microns, but with prolonged steeping time. For production of roasted cold brew the cacao skin or shell may be left on or removed. In the exemplary embodiment of the product this material is removed by one of various winnowing processes familiar to those skilled in the art. This cacao bean product is then added to water that is untreated, pre-purified, or pre-flavored. The ratio of cacao to cold water can vary between 1 and 50% by volume. This mixture is then steeped cold between 32 degrees F. and 45 degrees F. for times varying between 30 minutes and 3 days. The cacao solids are then filtered from the beverage utilizing one of several filtering techniques well known to those skilled in the art, such as gravitational filtration, drip filtration, press filtration, or centrifugation filtering performed continuously or in batches. The particle size, composition, and temperature all impact the ideal steeping time. We define three classes of beverage here, a light brew, which has subtle flavoring similar to other ‘flavored water’, a medium brew which has a flavor profile comparable to a moderate strength coffee, and a strong brew that has a flavor profile comparable to strong coffee. An exemplary light brew utilizes a 16 to 1 ratio by volume of water to ground cacao and is brewed for 6 to 24 hours. However, longer or shorter brewing times may be utilized to affect how much cocoa flavor the beverage has and how bitter it is. Longer times tend to make the brew more bitter while providing additional cacao flavor. A exemplary medium brew utilizes a water to ground cacao ratio of 8 to 1 by volume and is brewed for 6 to 36 hours. Again longer or shorter times may be utilized to produce a quality beverage. An exemplary strong brew utilizes a water to ground cacao ratio of 4 to 1 by volume and brewing times between 12 and 48 hours. A strong brew produced from pre-purified water of nominally neutral pH brewed for 12 hours resulted in a beverage with pH 6.7. Therefore the brewing process results in a naturally pH neutral beverage that is desirable to pH conscious consumers. Quality beverages may also be produced utilizing shorter or longer brewing times. Other ratios of water to ground cacao are suitable for producing a beverage, with stronger flavor resulting from larger amounts of cacao. These beverages may be sweetened to make them more palatable to consumers. The beverages can be sweetened with sugars, sugar alcohols, or calorie-free sweeteners, using compositions and water to sweetener ratios that are well known to those familiar with related arts such as coffee and tea manufacturing. Creamers, dairy and non-dairy, can be utilized to suppress bitter flavors in the drink and could be a desirable additive. Appropriate selection of creamer chemistry and composition would be elementary for those skilled in the art of related product production such as cold coffee. In each drink the salt concentration, by volume, should be in the range of 0.001 to 0.5%. To conclude the process, the beverage is preserved and packaged. A variety of techniques for bottling and preserving bottled beverages are known to those skilled in the art. The packaged product should have a shelf-life of at least 3 months, or 6 months, or 12 months.

In another example, a flavored cold brew is processed in a similar manner as described above for the green cold brew or roasted cold brew at any of the degrees of brewing; light brew, medium brew, or strong brew, but with the addition of supporting flavors. These supporting flavors may be added before, during, or after cold brewing. Three exemplary implementations are described here, using example flavors. However, a variety of flavorings could be implemented in a similar manner. An example almond cacao brew is produced by first soaking finely ground almonds, less than 100 micron, in water between 32 degrees F. and 45 degrees F. for 12 to 36 hours in order to produce an almond water. This almond water can then be used as the base to cold brew the flavored cacao water using the procedures described above for either a green cold brew or a roasted cold brew in the light brew, medium brew, or strong brew implementations. An example vanilla cacao cold brew is produced by adding one twentieth to one fifth of a vanilla bean per cup of water to the water ground cacao, raw, fermented, or roasted cacao mixture described above, which is then cold brewed following the procedure described above. An example coconut cacao cold brew is produced by first brewing a green cold brew or a roasted cold brew in the light brew, medium brew, or strong brew variety. A separate coconut concentrate is produced by either concentrating young coconut water or cold brewing dry shredded coconut in 32 to 45 degree F. water for 6 to 36 hours and concentrating the solution through one of a number of evaporative techniques well known to those skilled in the art. The coconut water concentrate is then mixed with the cold brewed cacao water to produce the resultant coconut cacao cold brew. These flavorants can contain soluble salts and the ideal total salt concentration, by volume, should be in the range of 0.001 to 0.5%.

1. J. P. E. Spencer, H. Schroeter, B. Shenoy, S. K. S. Srai, E. S. Debnam and C. Rice-Evans: Epicatechin is the primary bioavailable form of the procyanidin dimers B2 and B5 after transfer across the small intestine Biochem. Biophys. Res. Commun. 285(3), 588 (2001).

2. S. Carnesecchi, Y. Schneider, S. A. Lazarus, D. Coehlo, F. Gosse and F. Raul: Flavanols and procyanidins of cocoa and chocolate inhibit growth and polyamine biosynthesis of human colonic cancer cells Cancer Lett. (Shannon, Irel.). 175(2), 147 (2002).

3. R. R. Holt, S. A. Lazarus, M. C. Sullards, Q. Y. Zhu, D. D. Schramm, J. F. Hammerstone, C. G. Fraga, H. H. Schmitz and C. L. Keen: Procyanidin dimer B2 [epicatechin-(4β-8)-epicatechin] in human plasma after the consumption of a flavanol-rich cocoa Am. J. Clin. Nutr. 76(4), 798 (2002).

4. P. M. Kris-Etherton and C. L. Keen: Evidence that the antioxidant flavonoids in tea and cocoa are beneficial for cardiovascular health Curr. Opin. Lipidol. 13(1), 41 (2002).

5. T. K. Mao, J. van de Water, C. L. Keen, H. H. Schmitz and M. E. Gershwin: Modulation of TNF-a secretion in peripheral blood mononuclear cells by cocoa flavanols and procyanidins Dev. Immunol. (Taylor Francis). 9(3), 135 (2002).

6. T. K. Mao, J. Van De Water, C. L. Keen, H. H. Schmitz and M. E. Gershwin: Effect of cocoa flavanols and their related oligomers on the secretion of interleukin-5 in peripheral blood mononuclear cells J. Med. Food. 5(1), 17 (2002).

7. D. A. Pearson, T. G. Paglieroni, D. Rein, T. Wun, D. D. Schramm, J. F. Wang, R. R. Holt, R. Gosselin, H. H. Schmitz and C. L. Keen: The effects of flavanol-rich cocoa and aspirin on ex vivo platelet function Thromb. Res. 106(4-5), 191 (2002).

8. L. Y. Rios, R. N. Bennett, S. A. Lazarus, C. Remesy, A. Scalbert and G. Williamson: Cocoa procyanidins are stable during gastric transit in humans Am. J. Clin. Nutr. 76(5), 1106 (2002).

9. F. M. Steinberg, R. R. Holt, H. H. Schmitz and C. L. Keen: Cocoa procyanidin chain length does not determine ability to protect LDL from oxidation when monomer units are controlled J. Nutr. Biochem. 13(11), 645 (2002).

10. Q. Y. Zhu, R. R. Holt, S. A. Lazarus, J. L. Ensunsa, J. F. Hammerstone, H. H. Schmitz and C. L. Keen: Stability of the Flavan-3-ols Epicatechin and Catechin and Related Dimeric Procyanidins Derived from Cocoa J. Agric. Food Chem. 50(6), 1700 (2002).

11. Q. Y. Zhu, R. R. Holt, S. A. Lazarus, T. J. Orozco and C. L. Keen: Inhibitory effects of cocoa flavanols and procyanidin oligomers on free radical-induced erythrocyte hemolysis Exp. Biol. Med. (Maywood, N.J., U. S.). 227(5), 321 (2002).

12. N. D. Fisher, M. Hughes, M. Gerhard-Herman and N. K. Hollenberg: Flavanol-rich cocoa induces nitric-oxide-dependent vasodilation in healthy humans J. Hypertens. 21(12), 2281 (2003).

13. N. D. L. Fisher, M. Hughes, M. Gerhard-Herman and N. K. Hollenberg: Flavanol-rich cocoa induces nitric-oxide-dependent vasodilation in healthy humans J Hypertens. 21(12), 2281 (2003).

14. K. J. Murphy, A. K. Chronopoulos, I. Singh, M. A. Francis, H. Moriarty, M. J. Pike, A. H. Turner, N. J. Mann and A. J. Sinclair: Dietary flavanols and procyanidin oligomers from cocoa (Theobroma cacao) inhibit platelet function Am. J. Clin. Nutr. 77(6), 1466 (2003).

15. T. J. Orozco, J. F. Wang and C. L. Keen: Chronic consumption of a flavanol- and procyanidin-rich diet is associated with reduced levels of 8-hydroxy-2′-deoxyguanosine in rat testes J. Nutr. Biochem. 14(2), 104 (2003).

16. D. D. Schramm, M. Karim, H. R. Schrader, R. R. Holt, N. J. Kirkpatrick, J. A. Polagruto, J. L. Ensunsa, H. H. Schmitz and C. L. Keen: Food effects on the absorption and pharmacokinetics of cocoa flavanols Life Sci. 73(7), 857 (2003).

17. I. Wiswedel, D. Hirsch, S. Kropf, M. Gruening, E. Pfister, T. Schewe and H. Sies: Flavanol-rich cocoa drink lowers plasma F2-isoprostane concentrations in humans Free Radical Biol. Med. 37(3), 411 (2004).

18. N. D. Fisher and N. K. Hollenberg: Flavanols for cardiovascular health: the science behind the sweetness J. Hypertens. 23(8), 1453 (2005).

19. C. G. Fraga, L. Actis-Goretta, J. I. Ottaviani, F. Carrasquedo, S. B. Lotito, S. Lazarus, H. H. Schmitz and C. L. Keen: Regular consumption of a flavanol-rich chocolate can improve oxidant stress in young soccer players Clin. Dev. Immunol. 12(1), 11 (2005).

20. C. Heiss, P. Kleinbongard, A. Dejam, S. Perre, H. Schroeter, H. Sies and M. Kelm: Acute consumption of flavanol-rich cocoa and the reversal of endothelial dysfunction in smokers J. Am. Coll. Cardiol. 46(7), 1276 (2005).

21. C. L. Keen, R. R. Holt, P. I. Oteiza, C. G. Fraga and H. H. Schmitz: Cocoa antioxidants and cardiovascular health Am. J. Clin. Nutr. 81(1S), 298S (2005).

22. H. Sies, T. Schewe, C. Heiss and M. Kelm: Cocoa polyphenols and inflammatory mediators Am. J. Clin. Nutr. 81(1S), 304S (2005).

23. V. Bayard, F. Chamorro, J. Motta and N. K. Hollenberg: Does flavanol intake influence mortality from nitric oxide-dependent processes? Ischemic heart disease, stroke, diabetes mellitus, and cancer in Panama Int. J. Med. Sci. 4(1), 53 (2006).

24. H. M. O. Farouque, M. Leung, S. A. Hope, M. Baldi, C. Schechter, J. D. Cameron and I. T. Meredith: Acute and chronic effects of flavanol-rich cocoa on vascular function in subjects with coronary artery disease: a randomized double-blind placebo-controlled study Clin. Sci. 111(1), 71 (2006).

25. N. D. Fisher and N. K. Hollenberg: Aging and vascular responses to flavanol-rich cocoa J. Hypertens. 24(8), 1575 (2006).

26. U. Heinrich, K. Neukam, H. Tronnier, H. Sies and W. Stahl: Long-term ingestion of high flavanol cocoa provides photoprotection against UV-induced erythema and improves skin condition in women J. Nutr. 136(6), 1565 (2006).

27. H. Schroeter, C. Heiss, J. Balzer, P. Kleinbongard, C. L. Keen, N. K. Hollenberg, H. Sies, C. Kwik-Uribe, H. H. Schmitz and M. Kelm: (-)-Epicatechin mediates beneficial effects of flavanol-rich cocoa on vascular function in humans Proc Natl Acad Sci U S A. 103(4), 1024 (2006).

28. C. Heiss, D. Finis, P. Kleinbongard, A. Hoffmann, T. Rassaf, M. Kelm and H. Sies: Sustained Increase in Flow-Mediated Dilation After Daily Intake of High-Flavanol Cocoa Drink Over 1 Week J. Cardiovasc. Pharmacol. 49(2), 74 (2007).

29. T. P. Kenny, C. L. Keen, H. H. Schmitz and M. E. Gershwin: Immune effects of cocoa procyanidin oligomers on peripheral blood mononuclear cells Exp. Biol. Med. (Maywood, N.J., U. S.). 232(2), 293 (2007).

30. R. R. Allen, L. Carson, C. Kwik-Uribe, E. M. Evans and J. W. Erdman, Jr.: Daily consumption of a dark chocolate containing flavanols and added sterol esters affects cardiovascular risk factors in a normotensive population with elevated cholesterol J. Nutr. 138(4), 725 (2008).

31. C. Andres-Lacueva, M. Monagas, N. Khan, M. Izquierdo-Pulido, M. Urpi-Sarda, J. Permanyer and R. M. Lamuela-Raventos: Flavanol and Flavonol Contents of Cocoa Powder Products: Influence of the Manufacturing Process J. Agric. Food Chem. 56(9), 3111 (2008).

32. J. Balzer, T. Rassaf, C. Heiss, P. Kleinbongard, T. Lauer, M. Merx, N. Heussen, H. B. Gross, C. L. Keen, H. Schroeter and M. Kelm: Sustained Benefits in Vascular Function Through Flavanol-Containing Cocoa in Medicated Diabetic Patients J. Am. Coll. Cardiol. 51(22), 2141 (2008).

33. K. Davison, A. M. Coates, J. D. Buckley and P. R. C. Howe: Effect of cocoa flavanols and exercise on cardiometabolic risk factors in overweight and obese subjects Int. J. Obes. 32(8), 1289 (2008).

34. D. Grassi, G. Desideri, S. Necozione, C. Lippi, R. Casale, G. Properzi, J. B. Blumberg and C. Ferri: Blood pressure is reduced and insulin sensitivity increased in glucose-intolerant, hypertensive subjects after 15 days of consuming high-polyphenol dark chocolate J. Nutr. 138(9), 1671 (2008).

35. K. B. Miller, W. J. Hurst, M. J. Payne, D. A. Stuart, J. Apgar, D. S. Sweigart and B. Ou: Impact of alkalization on the antioxidant and flavanol content of commercial cocoa powders J. Agric. Food Chem. 56(18), 8527 (2008).

36. R. Muniyappa, G. Hall, T. L. Kolodziej, R. J. Karne, S. K. Crandon and M. J. Quon: Cocoa consumption for 2 wk enhances insulin-mediated vasodilatation without improving blood pressure or insulin resistance in essential hypertension Am. J. Clin. Nutr. 88(6), 1685 (2008).

37. O. Schnorr, T. Brossette, T. Y. Momma, P. Kleinbongard, C. L. Keen, H. Schroeter and H. Sies: Cocoa flavanols lower vascular arginase activity in human endothelial cells in vitro and in erythrocytes in vivo Arch. Biochem. Biophys. 476(2), 211 (2008).

38. F. A. Sorond, L. A. Lipsitz, N. K. Hollenberg and N. D. L. Fisher: Cerebral blood flow response to flavanol-rich cocoa in healthy elderly humans Neuropsychiatr. Dis. Treat. 4(2), 433 (2008).

39. W. Mullen, G. Borges, J. L. Donovan, C. A. Edwards, M. Serafini, M. E. J. Lean and A. Crozier: Milk decreases urinary excretion but not plasma pharmacokinetics of cocoa flavan-3-ol metabolites in humans Am. J. Clin. Nutr. 89(6), 1784 (2009).

40. R. J. Robbins, J. Leonczak, J. C. Johnson, J. Li, C. Kwik-Uribe, R. L. Prior and L. Gu: Method performance and multi-laboratory assessment of a normal phase high pressure liquid chromatography-fluorescence detection method for the quantitation of flavanols and procyanidins in cocoa and chocolate containing samples J. Chromatogr. A. 1216(24), 4831 (2009).

41. M. Urpi-Sarda, M. Monagas, N. Khan, R. Llorach, R. M. Lamuela-Raventos, O. Jauregui, R. Estruch, M. lzquierdo-Pulido and C. Andres-Lacueva: Targeted metabolic profiling of phenolics in urine and plasma after regular consumption of cocoa by liquid chromatography-tandem mass spectrometry J. Chromatogr. A. 1216(43), 7258 (2009).

42. S. Desch, J. Schmidt, D. Kobler, M. Sonnabend, I. Eitel, M. Sareban, K. Rahimi, G. Schuler and H. Thiele: Effect of Cocoa Products on Blood Pressure: Systematic Review and Meta-Analysis Am. J. Hypertens. 23(1), 97 (2010).

43. C. Heiss, S. Jahn, M. Taylor, W. M. Real, F. S. Angeli, M. L. Wong, N. Amabile, M. Prasad, T. Rassaf, J. I. Ottaviani, S. Mihardja, C. L. Keen, M. L. Springer, A. Boyle, W. Grossman, S. A. Glantz, H. Schroeter and Y. Yeghiazarians: Improvement of endothelial function with dietary flavanols is associated with mobilization of circulating angiogenic cells in patients with coronary artery disease J. Am. Coll. Cardiol. 56(3), 218 (2010).

44. A. B. Scholey, S. J. French, P. J. Morris, D. O. Kennedy, A. L. Milne and C. F. Haskell: Consumption of cocoa flavanols results in acute improvements in mood and cognitive performance during sustained mental effort J. Psychopharmacol. (London, U. K.). 24(10), 1505 (2010).

45. Z. A. Shah, R.-c. Li, A. S. Ahmad, T. W. Kensler, M. Yamamoto, S. Biswal and S. Dore: The flavanol (-)-epicatechin prevents stroke damage through the Nrf2/HO1 pathway J. Cereb. Blood Flow Metab. 30(12), 1951 (2010).

46. M. Nair, T. J. Kohr, K. Cessna, S. Cin, W. J. Hurst, A. L. Boldt, G. T. Zerphy, B. S. Baker and B. D. Brown: Steeped cocoa compositions and functional cocoa beverages made from them, (USA . City, 2011), pp. 14pp.

47. L. Nogueira, I. Ramirez-Sanchez, G. A. Perkins, A. Murphy, P. R. Taub, G. Ceballos, F. J. Villarreal, M. C. Hogan and M. H. Malek: (-)-Epicatechin enhances fatigue resistance and oxidative capacity in mouse muscle J. Physiol. (Oxford, U. K.). 589(18), 4615 (2011).

48. J. I. Ottaviani, T. Y. Momma, C. Heiss, C. Kwik-Uribe, H. Schroeter and C. L. Keen: The stereochemical configuration of flavanols influences the level and metabolism of flavanols in humans and their biological activity in vivo Free Radical Biol. Med. 50(2), 237 (2011).

49. X. Tzounis, A. Rodriguez-Mateos, J. Vulevic, G. R. Gibson, C. Kwik-Uribe and J. P. E. Spencer: Prebiotic evaluation of cocoa-derived flavanols in healthy humans by using a randomized, controlled, double-blind, crossover intervention study Am. J. Clin. Nutr. 93(1), 62 (2011).

50. L. Hooper, C. Kay, A. Abdelhamid, P. A. Kroon, J. S. Cohn, E. B. Rimm and A. Cassidy: Effects of chocolate, cocoa, and flavan-3-ols on cardiovascular health: a systematic review and meta-analysis of randomized trials Am. J. Clin. Nutr. 95(3), 740 (2012).

51. A. Helds: Preparation for treatment cardiovascular disorders, (Olalex, Sia, Latvia . City, 2014), p. 7pp.

52. J. A. White and S. S. Marine: The Buzz On Chocolate, (American Chemical Society, City, 2009), pp. CRM.

53. L. J. Dorfman and M. E. Jarvik: Comparative stimulant and diuretic actions of caffeine and theobromine in man Clin. Pharmacol. Ther. 11(6), 869 (1970). p 54. K. Matsagas, D. B. Lim, M. Horwitz, C. L. Rizza, L. D. Mueller, B. Villeponteau and M. R. Rose: Long-term functional side-effects of stimulants and sedatives in Drosophila melanogaster PLoS One. 4(8), No pp. given (2009).

55. M. J. Baggott, E. Childs, A. B. Hart, E. de Bruin, A. A. Palmer, J. E. Wilkinson and H. de Wit: Psychopharmacology of theobromine in healthy volunteers Psychopharmacology (Heidelberg, Ger.). 228(1), 109 (2013).

56. J. Chiovini, G. Margolis and M. Blanc: Recovery of xanthine stimulants from aqueous media, (Societe d'Assistance Technique pour Produits Nestle S. A., Switz. City, 1983), pp. 4 pp. Cont.

57. Y. Y. Yang, C.-W. D. Tan, S. M. Moochhala, L. Wang and D. Tan: Sustained-release tablet formulation for xanthine stimulants, (Agency for Science, Technology and Research, Singapore; DSO National Laboratories City, 2005), p. 15 pp.

58. R. Franco, A. Oñatibia-Astibia and E. Martinez-Pinilla: Health Benefits of Methylxanthines in Cacao and Chocolate Nutrients. 5(10), 4159 (2013).

59. N. H. de Graaf: Cocoa products, City, 1923).

60. G. Grindrod: Stable homogenized beverage, City, 1935).

61. L. Martens: A beverage with a milk-cacao base, City, 1942).

62. B. S. Wittingham: Stabilized chocolate sirup and beverage, (Colyer, Julian S.; Wanshel, Jerome N. . City, 1950).

63. F. M. Boyles: Beverage, (Cloverdale Spring Co., City, 1951).

64. H. Viermann: Readily soluble chocolate powder, (Diamalt Akt.-Ges. City, 1951).

65. G. Grindrod: Cacao-milk beverage, City, 1952).

66. A. McShea and A. M. Moroni: Chocolate extract, process of making, and uses thereof, (Theo Chocolates Inc., USA . City, 2010), p. 88pp.

67. H. Motegi, R. Minowa, H. Makabe and M. Mitsuhashi: The beverage which added the cacao extract and these [machine translation], (Showa Nogeikako Co., Japan; Suntory, Ltd. . City, 2007), p. 9pp.

68. M. Torres-Moreno, E. Torrescasana, J. Salas-Salvadó and C. Blanch: Nutritional composition and fatty acids profile in cocoa beans and chocolates with different geographical origin and processing conditions Food Chemistry. 166(0), 125 (2015).

69. S. T. Achor: Process of making soluble chocolate, City, 1892).

70. G. H. Neuhauss, J. F. H. Gronwald and E. Oehlmann: Method of preparing sterilized chocolate, (Germany City, 1891).

71. V. Tobias and H. Fischer: Preparing chocolate, City, 1890).

1. A method of producing a water based cocoa beverage comprising steeping cacao beans, or their processed components, in water below room temperature.

2. The method of claim 1, wherein the water steeped with cacao beans, or their processed components, is between approximately 32 to 45 degrees F.

3. A method of claim 1, wherein the steeping water contains no chemical additives that materially affect the steeping process.

4. The method of claim 1, where the resultant beverage is substantially fat free.

5. The method of claim 3, further comprising the addition of low-calorie sweetener.

6. The method of claim 5, wherein the low calorie sweetener is a natural extract.

7. The method of claim 5, wherein the low calorie sweetener is an artificial compound.

8. The method of claim 1, further comprising the packaging of the steeped cocoa beverage in a container whereby the product is stable for at least 3 months.

9. The method of claim 8, whereby the packaged beverage is stable for at least 6 months.

10. The method of claim 9, further comprising adding food preservatives.

11. The method of claim 9, further comprising the use of naturally extracted food preservatives.

12. The method of claim 9, further comprising the use of artificial food preservatives.

13. The method of claim 1, further comprising adding additional natural flavorings during the steeping process.

14. The method of claim 1, further comprising adding Na⁺ and K⁺ based salts to the beverage.

15. The method of claim 1, further comprising adding artificial flavorings.

16. The method of claim 13, further comprising steeping the cacao with edible grains, cereals, legumes, nuts, seeds, drupe seeds, gymnosperm seeds, roots, tubers, fruits, spices, or vegetables.

17. The method of claim 1, wherein the beverage is concentrated.

18. The method of claim 1, wherein the beverage is dehydrated.

19. The method of claim 1, further comprising a filtration step.

20. The method of claim 1, wherein both the initial water and resultant product is nominally pH neutral, i.e. 6.5<pH<7.5.

21. The method of claim 17, further comprising a filtration step.

22. The method of claim 19, comprising a continuous filtration process.

23. The method of claim 19, comprising a batch filtration process.

24. The method of claim 20, comprising a continuous filtration process.

25. The method of claim 20, comprising a batch filtration process.
